(19) United States
(12) Patent Application Publication
(10) Pub. No.: US 2007/0237350 A1
(43) Pub. Date: Oct. 11, 2007

(54) Dynamic loudspeaker

(76) Inventor: Craig Milnes, Sheffield (GB)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(21) Appl. No.: 11/392,392

(22) Filed: Mar. 29, 2006

(51) Int. Cl. H04R 9/06; H04R 11/02; H04R 1/00

(52) U.S. Cl. 381/396

(57) ABSTRACT

A dynamic loudspeaker comprises two spaced apart motor units (7,8) each incorporating a centre pole (12) operating in opposite phase resulting in cancellation of 3^{rd} order non-linearities, and the two motors (7,8) being linked together by a member (6) connecting both centre poles (12) of each motor unit (7,8).

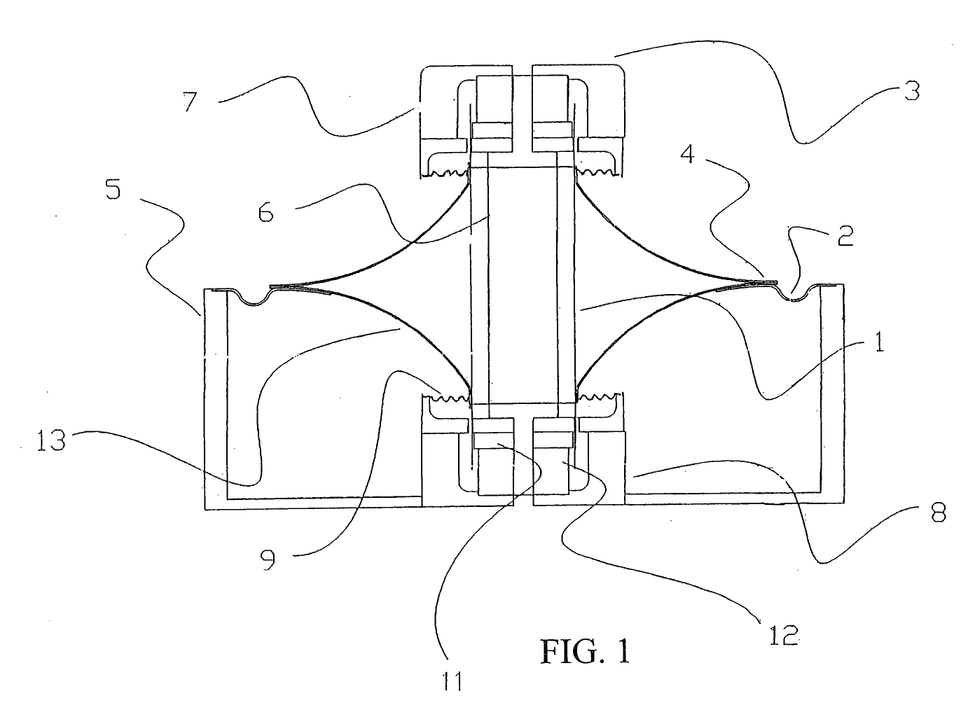

### FIELD OF THE INVENTION

This invention relates to a dynamic loudspeaker system.

### BACKGROUND OF THE INVENTION

The dynamic drive unit used by all dynamic loudspeaker systems is fabricated from a single motor with an external basket structure that obstructs the active component. Such a dynamic driver also suffers from structural problems relating to an open structure typically a cone used as the moving part that compresses and rarifies the air to generate sound. Compared to the invention the conventional dynamic driver sees performance drawbacks in terms of physical size, moving mass and numerous other performance criteria. Furthermore, with a view to eliminating resonance, the tendency is to offer loudspeakers with extremely stiff enclosures.

### SUMMARY OF THE INVENTION

According to the present invention there is provided a dynamic loudspeaker comprising:
(i) two spaced apart motor units each incorporating a centre pole operating in opposite phase resulting in cancellation of 3^{rd} order non-linearities; and
(ii) the two motor units being linked together by a member connecting both centre poles of each motor unit, whereby the connected motor units act as the main structural component of the loudspeaker.

### ADVANTAGES OF THE INVENTION

The invention not only provides a two motor unit loudspeaker but also eliminates the presence of structure that ordinarily would obstruct the conventional diaphragm(s), and provides improved thermal dynamic properties, reduced size compared with power output, and improved audio performance, as the invention eliminates the conventional use of a second surround, thus reducing the levels of distortion attributable to this component by half, and eliminates the need for a conventional external basket structure and hence eliminates any distortions relating to this obstructing structural component.

Furthermore, the invention enables lower frequencies to be generated with a given volume of air than single driver or multiple driver conventional Isobaric solutions, as the assembly of the composite two motor unit dynamic drive eliminates the need for any obstructing assemblies on both sides of the dynamic part of the system typical the diaphragm structure.

Finally, the effect of the connected motor units as the main structural component results in the enclosure not being subjected to vibrations, and hence enclosure stiffening of prior art loudspeakers to counter this effect is eliminated.

### PREFERRED OR OPTIONAL FEATURES

The linking member is metallic.

The linking member is solid.

The linking member is cylindrical.

The linking member is brass, copper or other heat conducting material whereby, in use, heat is conveyed by the linking member from the higher temperature motor to the lower temperature motor.

A diaphragm is provided having a high degree of stiffness compared with conventional diaphragms, whether conical or not, resulting in a super stiff diaphragm with attendant advantages resulting in near pistonic operation compared with conventional open cone designs, as the super stiff dynamic composite membrane structure defeats the passage of energy from within the enclosure escaping out to the listener.

The diaphragm is a carbon fibre composite.

The super stiff diaphragm is a closed structure as opposed to an open structure like a cone.

The diaphragm is positioned and aligned by one single surround at the largest diameter of the structure and two spider type supporting structures attached to each motor unit. The circular enclosure system provides the locating structure for the diaphragm surround locating system.

A clamshell composite driver is provided for generating accurate, low distortion, high level sound energy from a much smaller enclosure than would be possible with a single dynamic driver or with a two driver system mounted to create Isobaric loading.

The attachment of the motor units (first to second) is via an internal linking structure attached to the centre pole of the (second) motor unit.

A single voice coil former or similar structure is used to mount both voice coils which effectively links both motor coils together and provides a central internal structural member to the dynamic part that will guarantee maximum thermal similarities between both motor units and at the same time conduct away unwanted heat to the metal adjacent internal metal structure.

### DRAWINGS

A dynamic loudspeaker in accordance with the invention is shown diagrammatically, by way of example only, in the accompanying drawing, which illustrates basically a two motor, basketless, composite loudspeaker driver system.

The loudspeaker illustrated comprises a first motor unit 8 and a second motor unit 7 each having a centre pole 12, which centre poles are linked together by a metallic, heat conducting tube 6. Each motor unit 8,7 includes an Nd.Fe.B motor 11. The motor unit 8 is mounted in an end wall 14 of a composite enclosure structure 5 which includes sidewalls 15. A suspension unit in the form of a rubber surround 2 is attached to terminal edges 16 of the sidewalls 15 and to a bonded joint 4 at one edge of a clamshell diaphragm structure comprising sides 13 and 17, with the other edges of the sides 13 and 17 bonded at 18 to opposite ends of the tube 6. Cambric suspension elements 9 extend between the bonds 18 and each motor unit 8,7. A single voice coil is indicated at 1, while 3 indicates a back plate of each motor unit 8,7.

1. A dynamic loudspeaker comprising:
(i) two spaced apart motor units each incorporating a centre pole operating in opposite phase resulting in cancellation of 3^{rd} order non-linearities;
(ii) the two motor units being linked together by a member connecting both centre poles of each motor unit, whereby the connected motor units act as the main structural component of the loudspeaker; and
(iii) one motor unit being mounted in an end wall of a composite enclosure structure.

2. A loudspeaker as claimed in claim 1, wherein the linking member is metallic.

3. A loudspeaker as claimed in claim 1, wherein the linking member is solid.

4. A loudspeaker as claimed in claim 1, wherein the linking member is cylindrical.

5. A loudspeaker as claimed in claim 2, wherein the linking member is brass, copper or other heat conducting material whereby, in use, heat is conveyed by the linking member from the higher temperature motor to the lower temperature motor.

6. A loudspeaker as claimed in claim 1, comprising a diaphragm with a high degree of stiffness compared with conventional diaphragms, whether conical or not, resulting in a super stiff diaphragm.

7. A loudspeaker as claimed in claim 6, wherein the diaphragm is a carbon fibre composite.

8. A loudspeaker as claimed in claim 6, wherein the super stiff diaphragm is a closed structure as opposed to an open structure like a cone.

9. A loudspeaker as claimed in claim 6, wherein the diaphragm is positioned and aligned by one single surround at the largest diameter of the structure and two spider type supporting structures attached to each motor unit.

10. A loudspeaker as claimed in claim 1, wherein a clamshell composite driver is provided for generating accurate, low distortion, high level sound energy from a much smaller enclosure than would be possible with a single dynamic driver or with a two driver system mounted to create Isobaric loading.

11. A loudspeaker as claimed in claim 1, wherein the attachment of the motor units (first to second) is via an internal linking structure attached to the centre pole of the (second) motor unit.

12. A loudspeaker as claimed in claim 1, wherein a single voice coil former or similar structure is used to mount both voice coils which effectively links both motor coils together and provides a central internal structural member to the dynamic part that will guarantee maximum thermal similarities between both motor units and at the same time conduct away unwanted heat to the metal adjacent internal metal structure.
